(19) United States
(12) Patent Application Publication
(10) Pub. No.: US 2019/0009787 A1
(43) Pub. Date: Jan. 10, 2019

(54) VEHICLE CONTROL APPARATUS, VEHICLE CONTROL METHOD, AND VEHICLE CONTROL PROGRAM

(71) Applicant: HONDA MOTOR CO., LTD., Tokyo (JP)

(72) Inventor: Atsushi Ishioka, Utsunomiya-shi (JP)

(21) Appl. No.: 15/750,572

(22) PCT Filed: Jul. 20, 2016
(86) PCT No.: PCT/JP2016/071205

§ 371 Date: Feb. 6, 2018

(30) Foreign Application Priority Data
Aug. 19, 2015 (JP) 2015-162299

(51) Int. Cl. B60W 50/00

(52) U.S. Cl. CPC B60W 50/0097; G06K 9/00805

(57) ABSTRACT

A vehicle control apparatus includes: a detection unit that detects a second vehicle which is traveling around a first vehicle; and a prediction unit that predicts a future position of the second vehicle, based on a detection result of the detection unit and lane information of a road around the second vehicle.

### TECHNICAL FIELD

The present invention relates to a vehicle control apparatus, a vehicle control method, and a vehicle control program.

Priority is claimed on Japanese Patent Application No. 2015-162299 filed on Aug. 19, 2015, the contents of which are incorporated herein by reference.

### BACKGROUND

In the related art, a travel safety apparatus has been proposed in which: when information of an obstacle is not output from a radar device, an estimation means continuously estimates for a predetermined period of time at least the current value of a distance between a self-vehicle (hereinafter, also referred to as a first vehicle or simply a vehicle) and the obstacle on the basis of information that is stored in a storage unit until a time point when the information of the obstacle is not output from the radar device; and a contact possibility determination means determines the possibility of contact between the vehicle and the obstacle on the basis of information from the estimation means (for example, refer to Patent Document 1).

The apparatus described above includes an estimation time change means that changes an estimation time by the estimation means in response to the situation when the information of the obstacle is not output from the radar device. The estimation time change means sets the estimation time to be longer, for example, as the distance to the obstacle immediately before the information of the obstacle is not output is longer.

### RELATED ART DOCUMENTS

### Patent Documents

[Patent Document 1] Japanese Unexamined Patent Application, First Publication No. H6-174847

### SUMMARY OF INVENTION

### Problems to Be Solved by the Invention

However, in the technique of the related art, there is a case in which it is not possible to predict the position of a vehicle with good accuracy.

In view of the foregoing, an object of an aspect of the present invention is to predict the position of a vehicle with good accuracy.

### Means for Solving the Problem

(1) An aspect of the present invention is a vehicle control apparatus that is provided at least on a first vehicle, the apparatus including: a detection unit that detects a second vehicle which is traveling around the first vehicle; and a prediction unit that predicts a future position of the second vehicle, based on a detection result of the detection unit and lane information of a road around the second vehicle.

(2) In the above aspect (1), the prediction unit may predict a future position of the second vehicle as an existence probability of each lane.

(3) In the above aspect (1) or (2), the lane information of a road may at least include information that indicates a boundary of a lane or information that indicates a middle of the lane.

(4) In any one of the above aspects (1) to (3), the prediction unit may derive a probability density distribution of an existence of the second vehicle with respect to the lane information of the road and may predict a future position of the second vehicle as an existence probability of each lane, based on the derived probability density distribution.

(5) In the above aspect (4), the prediction unit may derive the probability density distribution, based on a position history of the second vehicle.

(6) In the above aspect (4) or (5), the prediction unit may derive the probability density distribution, based on information of an increase or decrease of a lane.

(7) In any one of the above aspects (4) to (6), the detection unit may further detect a third vehicle which is traveling around the second vehicle, and the prediction unit may derive a probability density distribution of an existence of the second vehicle with respect to the lane information of the road, reflecting a position of the third vehicle that is detected by the detection unit.

(8) In any one of the above aspects (4) to (7), the prediction unit may derive the probability density distribution, based on information that affects a behavior of the second vehicle.

(9) In any one of the above aspects (1) to (8), the prediction unit may predict, based on the future position of the second vehicle that is predicted by the prediction unit, a future position of the second vehicle that is a more future position than the predicted future position of the second vehicle.

(10) In any one of the above aspects (1) to (9), the vehicle control apparatus may further include a second vehicle-tracking unit that estimates, when the second vehicle becomes undetected by the detection unit, based on the future position of the second vehicle that is predicted by the prediction unit, a position of the second vehicle that becomes undetected by the detection unit.

(11) In any one of the above aspects (1) to (10), the vehicle control apparatus may further include a second vehicle-tracking unit that determines, based on a comparison of a future position that is predicted by the prediction unit of the second vehicle which is previously detected by the detection unit with a position of a second vehicle which is detected by the detection unit, whether or not the second vehicle which is previously detected by the detection unit is identical to the second vehicle which is detected by the detection unit.

(12) Another aspect of the present invention is a vehicle control method, including: detecting a second vehicle which is traveling around a first vehicle; and predicting a future position of the second vehicle, based on a detection result of the detected second vehicle and lane information of a road.

(13) Still another aspect of the present invention is a vehicle control program that causes a computer of a vehicle control apparatus which is provided at least on a first vehicle to: detect a second vehicle which is traveling around the first vehicle; and predict a future position of the second vehicle, based on a detection result of the detected second vehicle and lane information of a road.

### Advantage of the Invention

According to the aspects (1), (3), (4), (5), (12), and (13) described above, the prediction unit predicts a future position of the second vehicle on the basis of the detection result of the second vehicle that is detected by the detection unit and lane information of a road around the second vehicle, and thereby, it is possible to predict the position of a vehicle with good accuracy.

According to the aspect (2) described above, the prediction unit predicts a future position of the second vehicle as an existence probability of each lane, and thereby, it is possible to predict a lane at which the second vehicle will be positioned in the future with good accuracy.

According to the aspect (6) described above, the prediction unit derives the probability density distribution with respect to the lane information of the road on the basis of information of an increase or decrease of a lane, and thereby, it is possible to predict the position of a vehicle in consideration of a case in which a branching lane is present or a case in which a lane is increased or decreased.

According to the aspect (7) described above, the prediction unit derives a probability density distribution of the existence of the second vehicle with respect to the lane information of the road, reflecting the position of the third vehicle that is detected by the detection unit, and thereby, it is possible to predict the position of a vehicle in consideration of a peripheral vehicle of the second vehicle.

According to the aspect (8) described above, the prediction unit derives the probability density distribution on the basis of information that affects the behavior of the second vehicle, and thereby, it is possible to predict the position of a vehicle with further good accuracy.

According to the aspect (9) described above, on the basis of the future position of the second vehicle that is predicted by the prediction unit, a future position of the second vehicle that is a further future position than the predicted future position of the second vehicle is predicted, and thereby, it is possible to predict the future position of a vehicle with further good accuracy.

According to the aspect (10) described above, when the second vehicle becomes undetected by the detection unit, the second vehicle-tracking unit estimates the position of the second vehicle that becomes undetected by the detection unit on the basis of the future position of the second vehicle that is predicted by the prediction unit, and thereby, it is possible to continue tracking the target second vehicle.

According to the aspect (11) described above, the second vehicle-tracking unit determines whether or not the second vehicle which is previously detected by the detection unit is identical to the second vehicle which is detected by the detection unit, and thereby, it is possible to predict the sameness of second vehicles that are detected at a different time with good accuracy.

### BRIEF DESCRIPTION OF THE DRAWINGS

FIG. 1 is a view showing a configuration element that is included in a vehicle on which a vehicle control apparatus according to a first embodiment is mounted.

FIG. 2 is a function configuration view of a vehicle focusing on the vehicle control apparatus according to the first embodiment.

FIG. 3 is a view showing an example of map information.

FIG. 4 is a view showing an example of information for links.

FIG. 5 is a view showing a state in which the relative position of a vehicle with respect to a travel lane is recognized by a vehicle position recognition unit.

FIG. 6 is a view showing an example of an action plan that is generated with respect to a zone.

FIG. 7 is a flowchart showing an example of the flow of a process that is performed by a second vehicle-tracking unit and a second vehicle position prediction unit.

FIG. 8 is a flowchart showing an example of the flow of a process in which the second vehicle position prediction unit derives a probability density distribution.

FIG. 9 is a view schematically showing a state in which a probability density distribution is derived.

FIG. 10 is an example of a probability density distribution when derived without consideration of lane information.

FIG. 11 is an example of a probability density distribution when derived in consideration of lane information.

FIG. 12 is an example of a probability density distribution when derived without consideration of lane information in a scene in which a branch of a road is present.

FIG. 13 is an example of a probability density distribution when derived in consideration of lane information in a scene in which a branch of a road is present.

FIG. 14 is a view showing derivation of a probability density distribution of the future position of a second vehicle.

FIG. 15 is an example of a scene in which the probability density distribution is derived by using a position history of the second vehicle.

FIG. 16 is a view showing an example of a scene in which the probability density distribution of the second vehicle is derived on the basis of future prediction of the position of a third vehicle.

FIG. 17 is a view showing a scene in which the probability density distribution is corrected.

FIG. 18 is an example of a probability density distribution when derived in consideration of the type of a lane.

### DESCRIPTION OF THE EMBODIMENTS

Hereinafter, a vehicle control apparatus, a vehicle control method, and a vehicle control program according to embodiments of the present invention are described with reference to the drawings.

### First Embodiment

### Vehicle Configuration

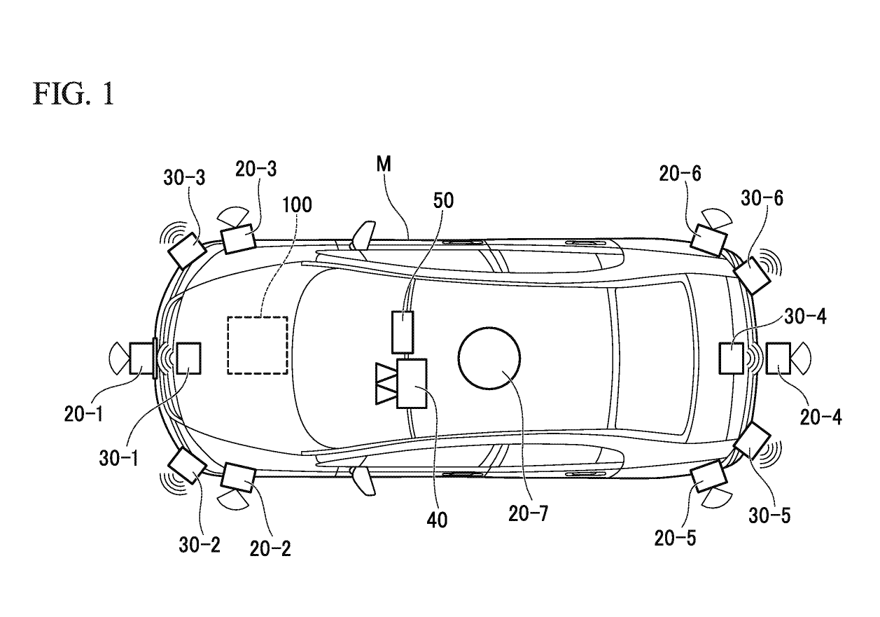

FIG. 1 is a view showing a configuration element that is included in a vehicle M (hereinafter, also referred to as a first vehicle M) on which a vehicle control apparatus 100 according to a first embodiment is mounted. A vehicle on which the vehicle control apparatus 100 is mounted is, for example, an automobile having two wheels, three wheels, four wheels, or the like and includes an automobile using an internal combustion engine such as a diesel engine or a gasoline engine as a power source, an electric automobile using an electric motor as a power source, a hybrid automobile including both an internal combustion engine and an electric motor, and the like. The above-described electric automobile is driven, for example, by using electric power that is discharged by a battery such as a secondary battery, a hydrogen fuel cell, a metallic fuel cell, and an alcohol fuel cell.

As shown in FIG. 1, a vehicle includes: a sensor such as finders 20-1 to 20-7, radars 30-1 to 30-6, and a camera 40; a navigation device 50; and the vehicle control apparatus 100. The finders 20-1 to 20-7 are, for example, LIDARs (Light Detection and Ranging, or Laser Imaging Detection and Ranging) that measure scattered light with respect to irradiation light and that measure a distance to a target. For example, the finder 20-1 is attached to a front grille or the like, and the finders 20-2 and 20-3 are attached to a side surface of a vehicle body, a door mirror, the inside of a head lamp, the vicinity of a side lamp, or the like. The finder 20-4 is attached to a trunk lid or the like, and the finders 20-5 and 20-6 are attached to a side surface of the vehicle body, the inside of a tail lamp, or the like. The finders 20-1 to 20-6 have, for example, a detection range of about 150 degrees with respect to a horizontal direction. The finder 20-7 is attached to a roof or the like. The finder 20-7 has, for example, a detection range of 360 degrees with respect to the horizontal direction.

The radars 30-1 and 30-4 are, for example, long-distance millimeter-wave radars having a wider detection range in a depth direction than that of other radars. The radars 30-2, 30-3, 30-5, and 30-6 are middle-distance millimeter-wave radars having a narrower detection range in the depth direction than those of the radars 30-1 and 30-4. Hereinafter, when the finders 20-1 to 20-7 are not specifically distinguished, the finders 20-1 to 20-7 are simply referred to as “a finder 20”, and when the radars 30-1 to 30-6 are not specifically distinguished, the radars 30-1 to 30-6 are simply referred to as “a radar 30”. The radar 30 detects an object, for example, using a FM-CW (Frequency-Modulated Continuous Wave) method.

The camera 40 is, for example, a digital camera that utilizes a solid-state imaging element such as a CCD (Charge-Coupled Device) or a CMOS (Complementary Metal Oxide Semiconductor). The camera 40 is attached to an upper part of a front window shield, a rear surface of a room mirror, or the like. The camera 40 periodically and repeatedly captures, for example, an image of the frontward direction of the vehicle M.

The configuration shown in FIG. 1 is merely an example; and part of the configuration may be omitted, or another configuration may be further added.

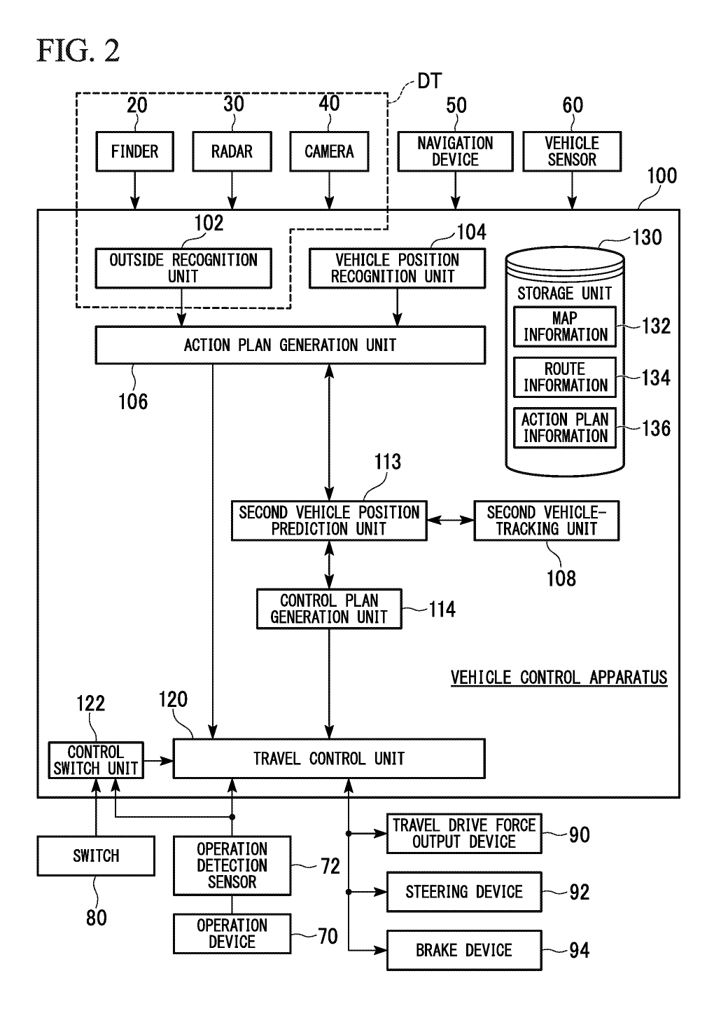

FIG. 2 is a function configuration view of the vehicle M focusing on the vehicle control apparatus 100 according to the first embodiment. The vehicle M includes the navigation device 50, a vehicle sensor 60, an operation device 70, an operation detection sensor 72, a switch 80, a travel drive force output device 90, a steering device 92, a brake device 94, and the vehicle control apparatus 100 in addition to the finder 20, the radar 30, and the camera 40.

The navigation device 50 has a GNSS (Global Navigation Satellite System) receiver, map information (navigation map), a touch-panel display device that functions as a user interface, a speaker, a microphone, and the like. The navigation device 50 identifies the position of the vehicle M by the GNSS receiver and derives a route to a destination that is assigned by a user from the position. The route that is derived by the navigation device 50 is stored in a storage unit 130 as route information 134. The position of the vehicle M may be identified or supplemented by an INS (Inertial Navigation System) that utilizes the output of the vehicle sensor 60. The navigation device 50 performs a guide with respect to the route to the destination by speech or a navigation display when the vehicle control apparatus 100 is performing a manual driving mode. The configuration that identifies the position of the vehicle M may be provided independently from the navigation device 50. The navigation device 50 may be implemented by, for example, a function of a terminal apparatus such as a smartphone or a tablet terminal which a user has. In this case, transmission and reception of information are performed using a radio frequency or by a communication between the terminal apparatus and the vehicle control apparatus 100.

The vehicle sensor 60 includes: a vehicle speed sensor that detects the speed (vehicle speed) of the vehicle M; an acceleration sensor that detects acceleration; a yaw rate sensor that detects an angular speed around a vertical axis; an azimuth sensor that detects the direction of the vehicle M; and the like.

The operation device 70 includes, for example, an accelerator pedal, a steering wheel, a brake pedal, a shift lever, and the like. An operation detection sensor 72 that detects the presence or absence of an operation by a driver and the amount of the operation is attached to the operation device 70. The operation detection sensor 72 includes, for example, an accelerator opening degree sensor, a steering torque sensor, a brake sensor, a shift position sensor, and the like. The operation detection sensor 72 outputs an accelerator opening degree, a steering torque, a brake press amount, a shift position, and the like as a detection result to the travel control unit 120. Alternatively, the detection result of the operation detection sensor 72 may be output directly to the travel drive force output device 90, the steering device 92, or the brake device 94

The switch 80 is a switch that is operated by a driver and the like. The switch 80 may be, for example, a mechanical switch or may be a GUI (Graphical User Interface) switch that is provided on the touch-panel display device of the navigation device 50. The switch 80 accepts a switch command between a manual driving mode in which the driver manually performs driving and an automated driving mode in which the vehicle travels in a state where the driver does not perform an operation (alternatively, the operation amount is smaller compared to the manual driving mode, or the operation frequency is low) and generates a control mode designation signal that designates the control mode by the travel control unit 120 to any one of the automated driving mode and the manual driving mode.

The travel drive force output device 90 includes, for example, one or both of an engine and a travel motor. When the travel drive force output device 90 has only an engine, the travel drive force output device 90 further includes an engine ECU (Electronic Control Unit) that controls the engine. The engine ECU adjusts a throttle-opening degree, a shift step, and the like, for example, in accordance with information that is input from the travel control unit 120 and thereby controls a travel drive force (torque) by which the vehicle travels. When the travel drive force output device 90 has only a travel motor, the travel drive force output device 90 includes a motor ECU that drives the travel motor. For example, the motor ECU adjusts the duty ratio of a PWM signal that is given to the travel motor and thereby controls a travel drive force by which the vehicle travels. When the travel drive force output device 90 includes both an engine and a travel motor, both of the engine ECU and the motor ECU control a travel drive force in a coordinated manner.

The steering device 92 includes, for example, an electric motor that applies a force to a rack-and-pinion function and the like and that is capable of changing the direction of a steering wheel, a steering angle sensor that detects a steering angle (or actual steering angle), and the like. The steering device 92 drives the electric motor in accordance with information that is input from the travel control unit 120.

The brake device 94 includes: a master cylinder in which a brake operation that is applied to a brake pedal is transmitted as an oil pressure; a reservoir tank that reserves a brake fluid; a brake actuator that adjusts a brake force which is output to each wheel; and the like. The brake device 94 controls a brake actuator and the like such that a brake torque having a desired amplitude is output to each wheel in accordance with information that is input from the travel control unit 120. The brake device 94 is not limited to the above-described electronically-controlled brake device which is operated by the oil pressure and may be an electronically-controlled brake device which is operated by an electric actuator.

### Vehicle Control Apparatus

Hereinafter, the vehicle control apparatus 100 is described. The vehicle control apparatus 100 includes, for example, an outside recognition unit 102, a vehicle position recognition unit 104, an action plan generation unit 106, a second vehicle-tracking unit 108, a second vehicle position prediction unit 113, a control plan generation unit 114, the travel control unit 120, a control switch unit 122, and a storage unit 130. Part of or all of the outside recognition unit 102, the vehicle position recognition unit 104, the action plan generation unit 106, the second vehicle-tracking unit 108, the second vehicle position prediction unit 113, the control plan generation unit 114, the travel control unit 120, and the control switch unit 122 are software function units that function by executing a program by a processor such as a CPU (Central Processing Unit). Part of or all of the units may be hardware function units such as a LSI (Large-Scale Integration) and an ASIC (Application-Specific Integrated Circuit). The storage unit 130 is implemented by a ROM (Read-Only Memory), a RAM (Random-Access Memory), a HDD (Hard Disk Drive), a flash memory, and the like. The program may be stored in the storage unit 130 in advance or may be downloaded from an external device via an in-vehicle Internet system and the like. The program may be installed in the storage unit 130 by mounting a portable storage medium that stores the program on a drive device (not shown).

The outside recognition unit 102 recognizes the state of the position, the speed, and the like of another vehicle on the basis of the output of the finder 20, the radar 30, the camera 40, and the like. The other vehicle in the present embodiment is a vehicle that is traveling around the vehicle M and is a vehicle that is traveling in the same direction as the vehicle M. Hereinafter, the other vehicle is referred to as a second vehicle. The number of the vehicle that is traveling around the vehicle M (first vehicle) and that is traveling in the same direction as the vehicle M is not limited to one. Accordingly, the other vehicle may be referred to as a second vehicle, a third vehicle, a fourth vehicle, and the like. That is, the other vehicle includes one or more vehicles other than the vehicle M. In the following description, the second vehicle represents the other vehicle, that is, a vehicle other than the vehicle M. The position of the second vehicle may be represented by a representative point such as the center of gravity or a corner of the second vehicle or may be represented by a region that is described by the outline of the second vehicle. The “state” of the second vehicle may include the acceleration of the second vehicle and whether or not the second vehicle is performing a lane change (or whether or not the second vehicle will perform a lane change) on the basis of the information of the devices described above. The outside recognition unit 102 recognizes whether or not the second vehicle is performing a lane change (or whether or not the second vehicle will perform a lane change) on the basis of the position history of the second vehicle, the operation state of a direction indicator, and the like. The outside recognition unit 102 may recognize positions of a guardrail, a power pole, a parked vehicle, a pedestrian, and other objects in addition to the second vehicle. Hereinafter, the combination of the finder 20, the radar 30, the camera 40, and the outside recognition unit 102 is referred to as a “detection unit DT” that detects the second vehicle. The detection unit DT may further recognize the state of the position, the speed, and the like of a second vehicle by a communication with the second vehicle.

The vehicle position recognition unit 104 recognizes the lane (self-lane, travel lane) on which the vehicle M is travelling and the relative position of the vehicle M with respect to the travel lane on the basis of map information 132 that is stored in the storage unit 130 and information that is input from the finder 20, the radar 30, the camera 40, the navigation device 50, or the vehicle sensor 60.

The map information 132 is, for example, more accurate map information than a navigation map that is included in the navigation device 50. The map information 132 is, for example, a highly accurate map and includes information that indicates the center of a lane, information that indicates the boundary of a lane, or the like. The map information 132 is referred to when the action plan generation unit 106 generates an action plan or when the second vehicle position prediction unit 113 predicts the future position of the second vehicle. The map information 132 includes information for links 132A, target information, and a road lane correspondence table.

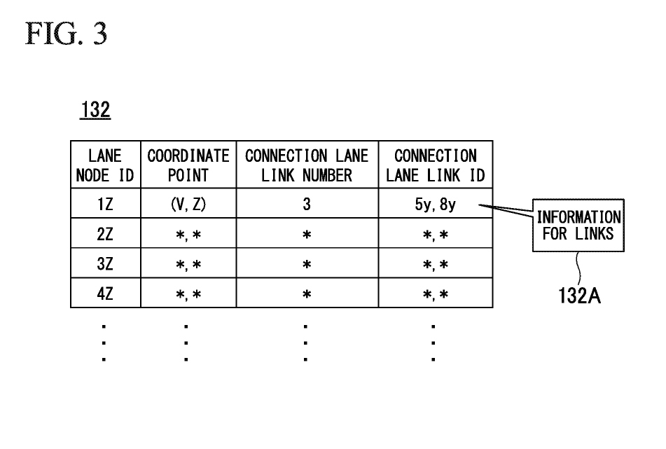

The map information 132 is a list of information that defines a lane node, which is a reference point on a lane reference line. The lane reference line is, for example, a center line between lanes. FIG. 3 is a view showing an example of the map information 132. A coordinate point, a connection lane link number, and a connection lane link ID are associated with each of a plurality of lane node IDs and are stored in the map information 132. The information for links 132A (lane information) is associated with the connection lane link ID of the map information 132.

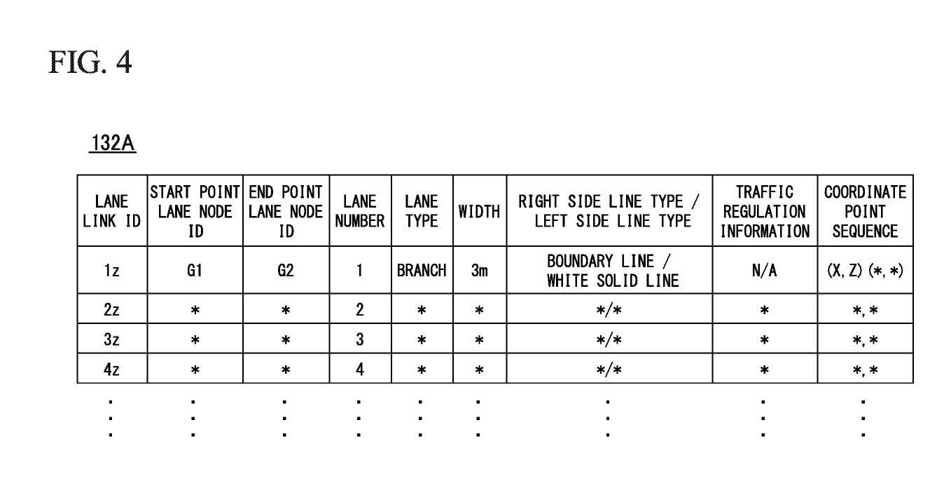

The information for links 132A is a list showing information of a zone state of a lane between a plurality of lane nodes. FIG. 4 is a view showing an example of information for links 132A. A lane node ID (start point lane node ID) that is connected as a start point of a lane link, a lane node ID (end point lane node ID) that is connected as an end point of a lane link, a lane number that indicates which lane from the left toward a vehicle proceeding direction of a lane, a lane type (for example, a branching lane, a merging lane, and the like), width information of a lane, a line type (right side line type, left side line type) that indicates the line type of the right side and left side lanes toward a vehicle proceeding direction of a lane, traffic regulation information that indicates the situation of a traffic regulation in a lane, and a coordinate point sequence of the shape of a lane reference line of a lane zone that is indicated by a lane link are associated with each of a plurality of lane link IDs and are stored in the information for links 132A. When the shape of a lane is special, the information for links 132A may store information (curvature and the like) used for describing the shape of the lane.

The object target information is a list of information that indicates an object target which is present on a road. Examples of the object target which is present on a road in the object target information include a signboard, a building, a signal, a pole, a power pole, and the like. In the object target information, the name of the object target, a coordinate point sequence that represents the outline of the object target, and a lane node ID at which the object target is present are associated with each of a plurality of object target IDs.

The road lane correspondence table is a list of a lane link or a lane node that corresponds to a road of a navigation map. For example, information that indicates the lane node ID and the lane link ID that are present in the vicinity of a road is stored in the road lane correspondence table.

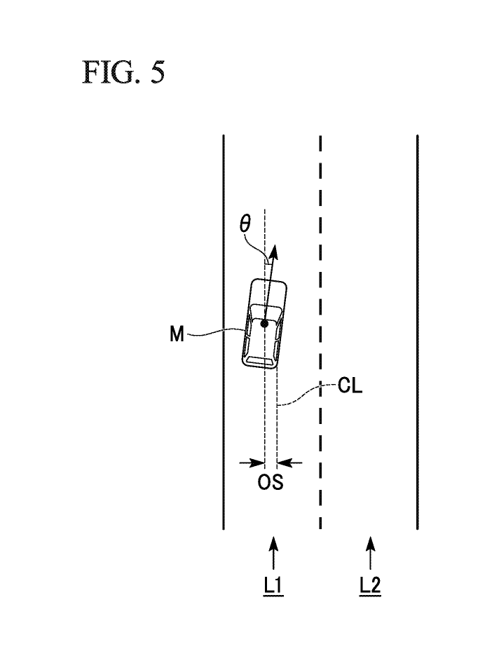

FIG. 5 is a view showing a state in which the relative position of the vehicle M with respect to a travel lane is recognized by the vehicle position recognition unit 104. For example, the vehicle position recognition unit 104 recognizes, as the relative position of the vehicle M with respect to the travel lane, a gap OS of a reference point (for example, the center of gravity) of the vehicle M from a travel lane center CL and an angle θ that is formed of the proceeding direction of the vehicle M and a line formed by connecting the travel lane centers CL. Alternatively, the vehicle position recognition unit 104 may recognize, as the relative position of the vehicle M with respect to the travel lane, the position of the reference point of the vehicle M with respect to any of side end parts of the lane L1 on which the vehicle M is traveling and the like.

The action plan generation unit 106 generates an action plan in a predetermined zone. The predetermined zone is, for example, a zone, which passes through a toll road such as an expressway, of the route that is derived by the navigation device 50. The predetermined zone is not limited thereto, and the action plan generation unit 106 may generate an action plan with respect to an arbitrary zone. The action plan generation unit 106 may generate an action plan on the basis of the position of the second vehicle that is predicted by the second vehicle position prediction unit 113.

The action plan is, for example, constituted of a plurality of events that are sequentially performed. Examples of the events include a deceleration event that decelerates the vehicle M, an acceleration event that accelerates the vehicle M, a lane-keeping event that causes the vehicle M to travel so as not to be deviated from the travel lane, a lane change event that causes the vehicle to change the travel lane, an overtaking event that causes the vehicle M to overtake a frontward vehicle, a branching event that causes the vehicle to change the lane to a desired lane at a branching point or that causes the vehicle M to travel so as not to be deviated from the current travel lane, a merging event that causes the vehicle M to accelerate or decelerate at a lane merging point to change the travel lane, and the like. For example, when a junction (branching point) is present in a toll road (for example, an expressway or the like), it is necessary for the vehicle control apparatus 100 to change the lane or keep the lane such that the vehicle M proceeds to a destination direction in an automated driving mode. Accordingly, when it is determined that a junction is present on the route with reference to the map information 132, the action plan generation unit 106 sets a lane change event that performs a lane change to a desired lane by which it is possible to proceed to the destination direction, at a position from the current position (coordinate) of the vehicle M to the position (coordinate) of the junction.

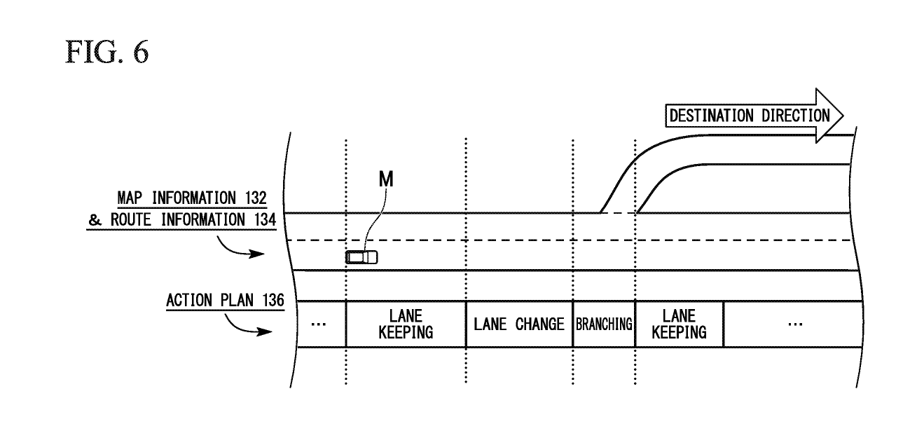

FIG. 6 is a view showing an example of an action plan that is generated with respect to a zone. As shown in the drawing, the action plan generation unit 106 categorizes situations that arise when traveling in accordance with the route to the destination and generates the action plan such that an event which is suitable for the individual situation is performed. The action plan generation unit 106 may change the action plan dynamically in response to the change in circumstances of the vehicle M.

The second vehicle-tracking unit 108 determines, on the basis of a comparison of a future position which is predicted by the second vehicle position prediction unit 113 of a second vehicle which is previously detected by the detection unit DT with a position of a second vehicle which is detected by the detection unit DT, whether or not the second vehicle which is previously detected by the detection unit DT is identical to the second vehicle which is detected by the detection unit DT.

The second vehicle position prediction unit 113 predicts a future position with respect to another vehicle. Another vehicle that becomes the target of prediction may be one vehicle (second vehicle), or a plurality of vehicles (second vehicle, third vehicle, fourth vehicle, and the like) may be simultaneously targets of position prediction. The second vehicle position prediction unit 113 predicts a future position of the second vehicle on the basis of a detection result of the detection unit DT and lane information that is information relating to a lane which is included in the map information 132 around the second vehicle. The second vehicle position prediction unit 113 predicts, for example, the future position of the second vehicle as an existence probability of each lane. For example, the second vehicle position prediction unit 113 outputs the predicted future position of the second vehicle to the control plan generation unit 114. The details of the process of the second vehicle position prediction unit 113 are described below.

### Control Plan

The control plan generation unit 114 generates a control plan additionally considering the prediction result of the second vehicle position prediction unit 113. Examples of the control plan include, a plan used for performing a lane change, a plan used for traveling so as to follow up a second vehicle that is traveling at a frontward position of the vehicle M, and the like.

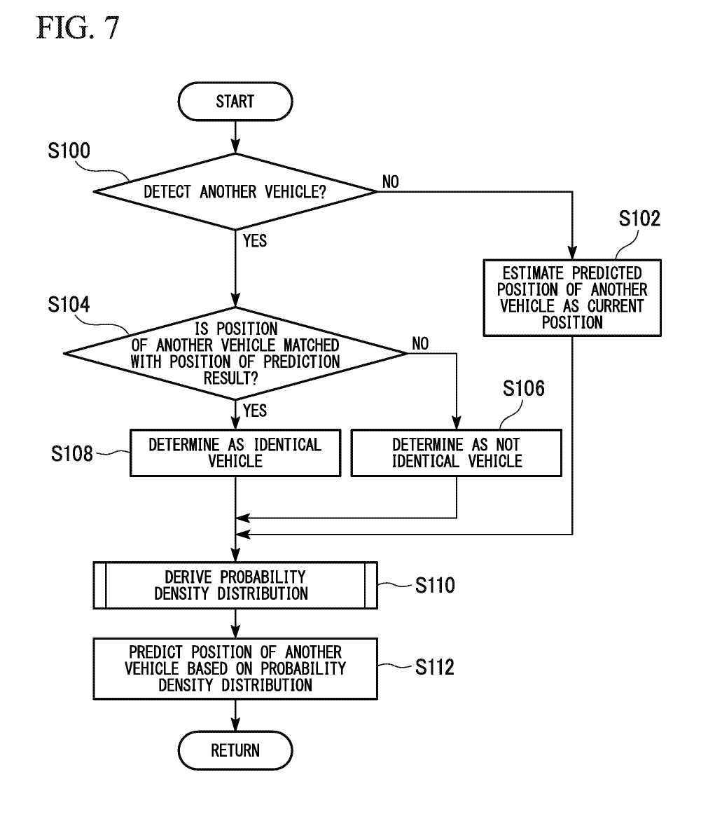

The process of the second vehicle position prediction unit 113 is described below with reference to a flowchart. FIG. 7 is a flowchart showing an example of the flow of a process that is performed by the second vehicle-tracking unit 108 and the second vehicle position prediction unit 113. The process of the present flowchart is a process that is repeatedly performed, for example, when the vehicle speed of the vehicle M is equal to or more than a reference speed.

First, the second vehicle-tracking unit 108 determines whether or not the current position of the second vehicle is detected by the detection unit DT (Step S100). When the current position of the second vehicle is not detected by the detection unit DT in Step S100, the second vehicle-tracking unit 108 estimates, as a position of the second vehicle, the position (current position in this routine) of the second vehicle that is predicted as a future position in Step S112 described below before or in the last routine (Step S102).

When the current position of the second vehicle is detected by the detection unit DT in Step S100, the second vehicle-tracking unit 108 compares the current position of the second vehicle that is detected in Step S100 with the position of the second vehicle that is predicted as a future position in Step S112 before or in the last routine and determines whether or not the comparison result is consistent (Step S104). When it is determined that the comparison result is not consistent in Step S104, the second vehicle-tracking unit 108 determines that the second vehicle that is detected in Step S100 is not identical to the second vehicle of which the position is detected or predicted before or in the last routine (of which the position is previously tracked) (Step S106). When it is determined that the comparison result is consistent in Step S104, the second vehicle-tracking unit 108 determines that the second vehicle that is detected in Step S100 is identical to the second vehicle of which the position is detected or predicted before or in the last routine (of which the position is previously tracked) (Step S108).

For example, the second vehicle-tracking unit 108 determines whether or not a second vehicle is identical to the second vehicle that is detected by the detection unit DT on the basis of the comparison of the position of the second vehicle that is detected by the detection unit DT in Step S100 with the future position of the second vehicle that is predicted according to a probability density distribution PD of the second vehicle which is derived by the second vehicle position prediction unit 113 in Step S112 before or in the last routine. For example, when the position of the second vehicle that is detected in Step S100 has an existence probability of a first threshold value or less in the probability density distribution PD of the future position of the second vehicle which is predicted in Step S112 before or in the last routine, the second vehicle-tracking unit 108 determines that the second vehicle which is detected in Step S100 is not identical to a second vehicle corresponding to the second vehicle which is predicted in Step S112. For example, when it is predicted that the second vehicle which is detected in Step S100 is present on a first lane, and the second vehicle which is predicted in Step S112 before or in the last routine is present on a second lane that is adjacent to the first lane, the second vehicle-tracking unit 108 may determine that the second vehicle which is detected in Step S100 is not identical to a second vehicle corresponding to the second vehicle which is predicted in Step S112.

On the other hand, when the position of the second vehicle that is detected in Step S100 has an existence probability exceeding the first threshold value in the probability density distribution PD of the position of the second vehicle which is predicted in Step S112 before or in the last routine, or when it is predicted that the second vehicle is present on the first lane, the second vehicle-tracking unit 108 determines that the second vehicle which is detected in Step S100 is identical to the second vehicle which is predicted in Step S112 before or in the last routine.

Next, the second vehicle position prediction unit 113 derives a probability density distribution PD of a future position with respect to the second vehicle (Step S110). The probability density distribution PD is a distribution that represents an existence probability of the second vehicle in the future with respect to the lateral direction and the longitudinal direction. The lateral direction is a direction that is orthogonal to the lane direction. The longitudinal direction is the lane direction (proceeding direction of the second vehicle). The details of the probability density distribution PD and a derivation method of the probability density distribution PD are described below. In the process of the present flowchart, the second vehicle position prediction unit 113 derives a future probability density distribution PD of the second vehicle on the basis of the position of the detected second vehicle, the position of the second vehicle that is previously detected, or the position of the second vehicle that is previously predicted (as a future position).

Next, the second vehicle position prediction unit 113 predicts a future position of the second vehicle on the basis of the probability density distribution PD that is derived in Step S110 (Step S112). For example, the second vehicle position prediction unit 113 calculates an existence probability of each lane as a probability density on the basis of the probability density distribution PD and predicts a lane on which the second vehicle is present from the calculation result. Thereby, the process of one routine of the present flowchart is finished.

As described above, by comparing a detection result of a second vehicle by the detection unit DT with a prediction result of the position of the second vehicle on the basis of the probability density distribution PD, the second vehicle-tracking unit 108 can detect the position of the second vehicle with further good accuracy. As a result, the second vehicle-tracking unit 108 can further reliably track the second vehicle.

In a specific example, when a second vehicle that is detected at a time T1 (process of a first routine) cannot be detected at a time T2 (process of a second routine) and is detected at a time T3 (process of a third routine), for example, the second vehicle-tracking unit 108 can determine whether or not the vehicle that is detected at the time T1 is identical to the vehicle that is detected at the time T3. For example, the second vehicle position prediction unit 113 compares the position of the vehicle that is detected at the time T3 with a probability density distribution PD corresponding to the time T3 of probability density distributions PD that are derived by the processes of the time T1 and the time T2 and determines whether or not the vehicle that is detected at the time T1 is identical to the vehicle that is detected at the time T3.

For example, when the position of the vehicle that is detected in the process of the time T3 has an existence probability of the first threshold value or less in the probability density distribution corresponding to the time T3 of the probability density distribution PD that is derived in the process of the time T1 (or the time T2), the second vehicle-tracking unit 108 predicts that the second vehicle which is detected or predicted in the process of the time T1 (or the time T2) is not identical to the vehicle that is detected in the process of the time T3.

On the other hand, when the position of the vehicle that is detected in the process of the time T3 has an existence probability that exceeds the threshold value in the probability density distribution corresponding to the time T3 of the probability density distribution PD that is derived in the process of the time T1 (or the time T2), the second vehicle-tracking unit 108 predicts that the vehicle which is detected in the process of the time T3 is identical to the second vehicle that is detected or predicted in the process of the time T1 (or the time T2). Thereby, even when it becomes temporarily impossible to detect the second vehicle, with reference to the probability density distribution PD of the position of the second vehicle, the second vehicle-tracking unit 108 does not lose the vehicle which has been tracked and can continue tracking the vehicle.

### Derivation Method of Probability Density Distribution

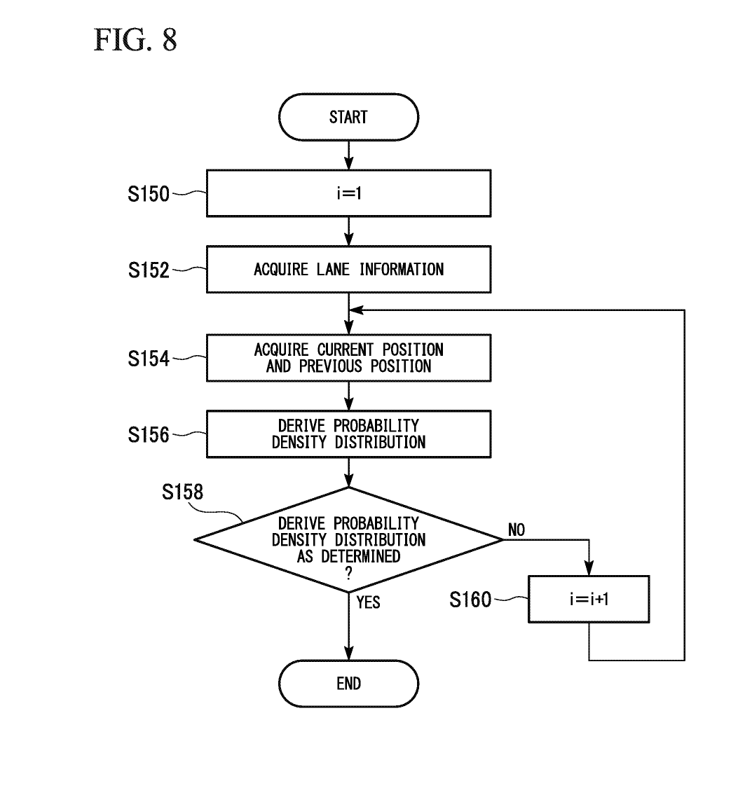

FIG. 8 is a flowchart showing an example of the flow of a process in which the second vehicle position prediction unit 113 derives the probability density distribution PD of the future position. First, the second vehicle position prediction unit 113 sets a parameter “i” to one as an initial value (Step S150). The parameter “i” is a parameter that indicates, for example, when prediction is performed at a temporal step width “t”, at which steps later the prediction is performed. As the parameter “i” becomes larger, the parameter “i” indicates prediction at a later step.

Next, the second vehicle position prediction unit 113 acquires lane information that is required for prediction of the future position of the second vehicle (Step S152). Next, the second vehicle position prediction unit 113 acquires the current position and the previous position of the second vehicle from the detection unit DT (Step S154). The current position that is acquired in Step S154 during a loop process of Step S154 to Step S160 may be treated as the “previous position” at or after the next process.

Next, the second vehicle position prediction unit 113 derives the probability density distribution PD of the future position of the second vehicle on the basis of the lane information that is acquired in Step S152, the current position and the previous position of the second vehicle that is acquired in Step S154, and the position of the second vehicle that is previously predicted (Step S156). When the current position of the second vehicle cannot be acquired from the detection unit DT in Step S154, the second vehicle position prediction unit 113 may use the position of the second vehicle that is previously predicted as the current position of the second vehicle.

Next, the second vehicle position prediction unit 113 determines whether or not probability density distributions PD of a predetermined step number are derived (Step S158). When it is determined that probability density distributions PD of the predetermined step number are not derived, the second vehicle position prediction unit 113 increments the parameter “i” by one (Step S160) and proceeds to the process of Step S152. When it is determined that probability density distributions PD of the predetermined step number are derived, the process of the present flowchart is finished. The predetermined step number may be one or more. The second vehicle position prediction unit 113 may derive a probability density distribution PD of one step or may derive probability density distributions PD of a plurality of steps.

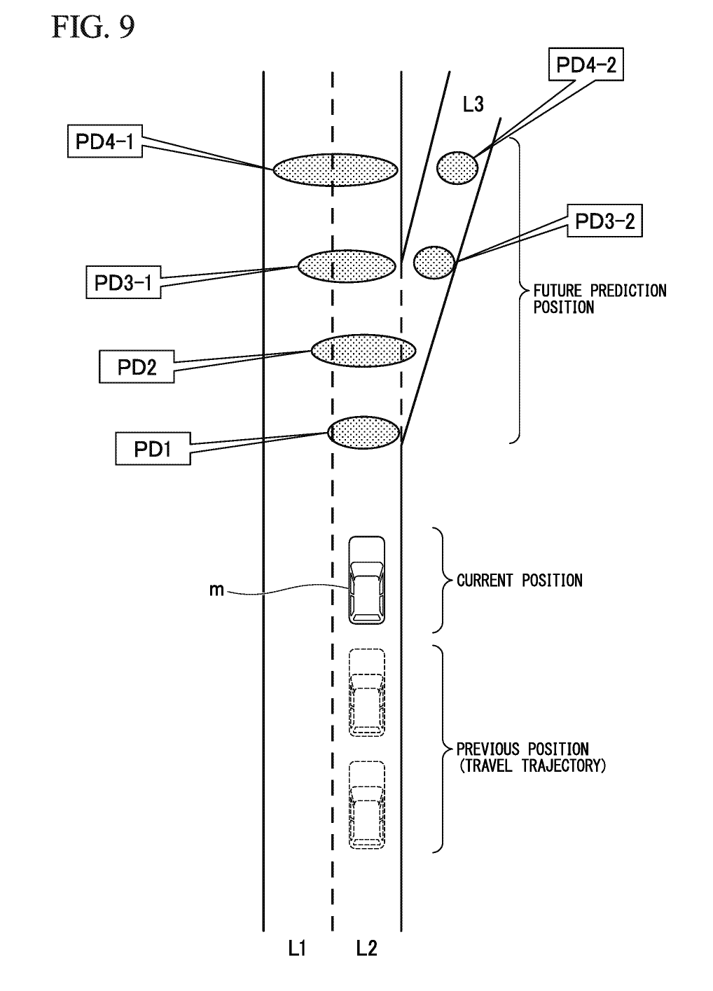

FIG. 9 is a view schematically showing a state in which a probability density distribution PD is derived. The second vehicle position prediction unit 113 derives the probability density distribution PD at each step (corresponding to the parameter “i”) on the basis of the current position, the previous position, and the predicted future position of the second vehicle m and the lane information. In the example of FIG. 9, the second vehicle position prediction unit 113 derives probability density distributions PD1 to PD4-1 and PD4-2 of four steps.

First, the second vehicle position prediction unit 113 derives a probability density distribution PD1 of a first step on the basis of the current position and the previous position of the second vehicle m. Next, the second vehicle position prediction unit 113 derives a probability density distribution PD2 of a second step on the basis of the probability density distribution PD1 that is derived at the first step and the current position and the previous position of the second vehicle m. Next, the second vehicle position prediction unit 113 derives probability density distributions PD3-1 and PD3-2 of a third step on the basis of the probability density distribution PD2 that is derived at the second step, the probability density distribution PD1 that is derived at the first step, and the current position and the previous position of the second vehicle m. Similarly, the second vehicle position prediction unit 113 derives probability density distributions PD4-1 and PD4-2 of a fourth step on the basis of the probability density distributions PD (PD1 to PD3-2) that are derived at each step and the current position and the previous position of the second vehicle m.

For example, when the probability density distribution PD1 is derived, the second vehicle position prediction unit 113 can predict the position of the second vehicle that corresponds to the first step on the basis of the probability density distribution PD1. For example, when the probability density distributions PD1 to PD4-2 are derived, the second vehicle position prediction unit 113 can predict the position of the second vehicle of the first step to the fourth step on the basis of the probability density distributions PD1 to PD4-2. In this way, the second vehicle position prediction unit 113 can predict the future position of the second vehicle that corresponds to an arbitrary step on the basis of the derived probability density distribution PD.

For example, when a second vehicle m is traveling, the second vehicle position prediction unit 113 derives the probability density distribution PD such that the broadening of the probability density distribution PD is increased as the time elapses. This is described below.

The second vehicle position prediction unit 113 may derive the probability density distribution PD at reference distances in place of temporal steps. The second vehicle position prediction unit 113 may limit the range in which the probability density distribution PD is derived to be closer than the range in which the second vehicle is recognized by the outside recognition unit 102.

In this way, the second vehicle position prediction unit 113 predicts the position of the second vehicle m by using the lane information and therefore can predict the position of the vehicle with good accuracy.

When the second vehicle position prediction unit 113 derives the probability density distribution PD on the basis of the current position, the previous position, and the predicted future position of the second vehicle m without using the lane information, the probability density distribution PD is derived without consideration of the lane of a road, the width of a road, and the like.

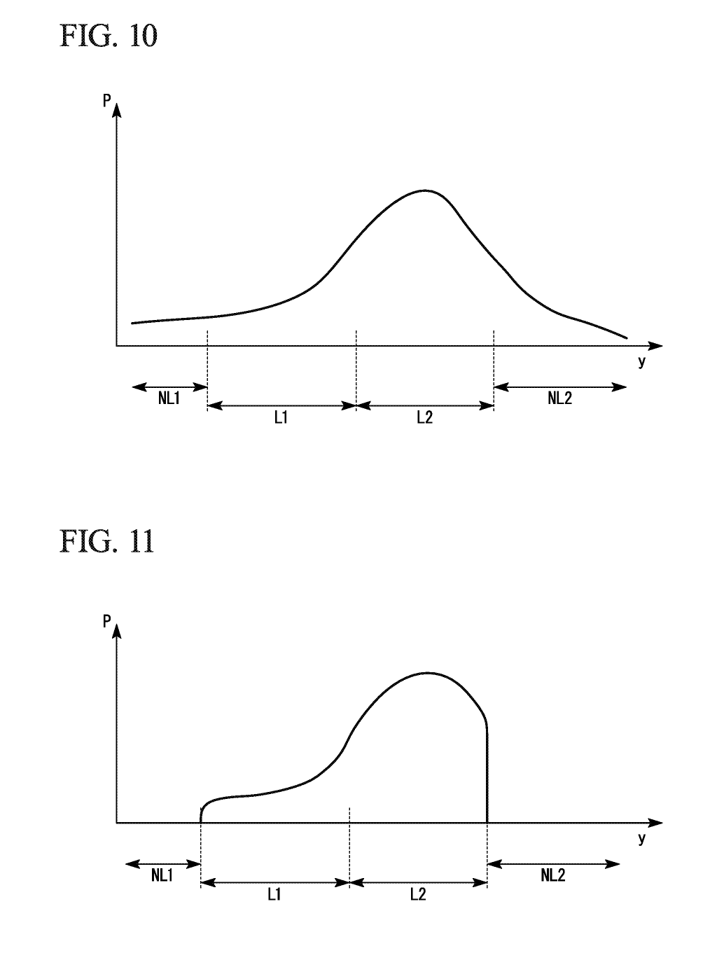

FIG. 10 is an example of a probability density distribution PD when derived without consideration of the lane information.

The vertical axis P represents an existence probability density of the second vehicle m, and the horizontal axis represents a displacement in the lateral direction of a road. A region L1 that is partitioned by dotted lines represents a lane L1 that is virtually shown for description, and a region L2 that is partitioned by dotted lines represents a lane L2 that is virtually shown for description. When the lane information is not used, there is a case in which the existence probability density of the second vehicle m is calculated even in regions NL1 and NL2 where a road is not present.

On the other hand, in the present embodiment, the second vehicle position prediction unit 113 derives the probability density distribution PD by using the lane information of the map information 132, and therefore, it is possible to derive a probability density distribution PD in consideration of the lane information such as the lane of a road and the width of a road. As a result, it is possible to predict the position of a vehicle with good accuracy.

FIG. 11 is an example of a probability density distribution PD when derived in consideration of lane information. In this case, the existence probability density of the second vehicle m is not calculated (is calculated as zero) in a part where a lane is not present, and the existence probability density of the second vehicle m is calculated only within the width of the road.

For example, the second vehicle position prediction unit 113 derives the probability density distribution PD without consideration of the lane information, then corrects the probability density distribution PD on the basis of the lane information, and derives the probability density distribution PD in consideration of the lane information. For example, the second vehicle position prediction unit 113 adds the probability density of the part that is made to be zero to another part and thereby derives the probability density distribution PD after correction. The method of addition is not specifically limited. For example, the addition may be made using a distribution according to a normal distribution using an average value in the y direction as the center.

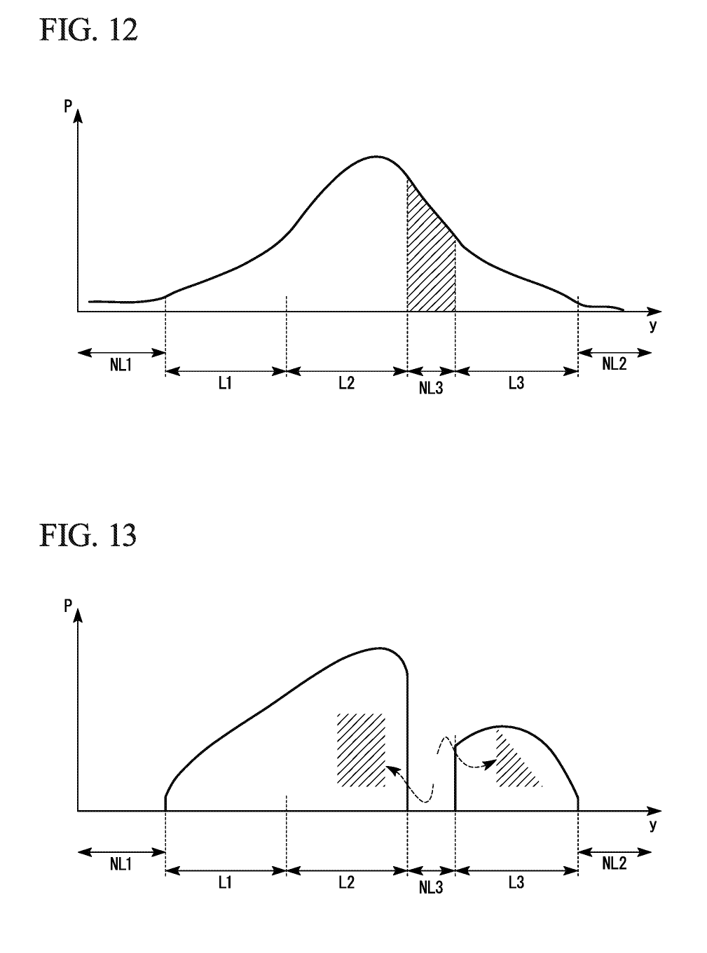

FIG. 12 is an example of a probability density distribution PD when derived without consideration of lane information in a scene in which a branch of a road is present. Regions L1, L2, and L3 that are partitioned by dotted lines represent lanes L1, L2, and L3 that are virtually shown for description. In FIG. 12, “L3” represents a lane of a road branch destination of the lanes L1 and L2 (refer to FIG. 9). When the lane information is not used, there is a case in which the existence probability of the second vehicle m is calculated even in regions NL1, NL2, and NL3 where a road is not present.

On the other hand, FIG. 13 is an example of a probability density distribution PD when derived in consideration of lane information in a scene in which a branch of a road is present. In the present embodiment, the second vehicle position prediction unit 113 derives the probability density distribution PD by using the lane information, and therefore, it is possible to derive a probability density distribution PD in consideration of a branch lane. The second vehicle position prediction unit 113 distributes the probability density of the region NL3 where a road is not present into a lane L1 and a lane L2, and a branch lane L3 and thereby can derive a probability density distribution PD in consideration of a branch lane. For example, the second vehicle position prediction unit 113 distributes the probability density of the region NL3 according to the ratio of the probability density of the lane L1 and the lane L2 and the probability density of the branch lane L3 and thereby derives the probability density distribution PD in consideration of a branch lane.

Thereby, the second vehicle position prediction unit 113 can derive a probability density distribution PD in consideration of a branch lane.

In this way, the second vehicle position prediction unit 113 predicts the position of the second vehicle m on the basis of the probability density distribution PD. The control plan generation unit 114 can generate, for example, a control plan used for performing a lane change on the basis of the position of the second vehicle m that is predicted by the second vehicle position prediction unit 113.

Specifically, for example, the second vehicle position prediction unit 113 derives the probability density distribution PD of the future position of the second vehicle m on the basis of the position of the second vehicle m, lane information, and Expression (1) described below as a probability density function. The second vehicle position prediction unit 113 calculates the value of the function f for each displacement (x, y). For example, “x” is a relative displacement regarding the proceeding direction of the second vehicle m with respect to the vehicle M. For example, “y” is a displacement in the lateral direction of the second vehicle m. “μₓ” is an average value of a relative displacement (previous, current, or future relative displacement) regarding the proceeding direction of the second vehicle m with respect to the vehicle M. “μ_{y}” is an average value of a position (previous, current, or future position) regarding the lateral direction of the second vehicle m. “σₓ²” is a dispersion of the relative displacement regarding the proceeding direction of the second vehicle m. “σ_{y}²” is a dispersion of the position regarding the lateral direction of the second vehicle m.

$$f ( x , y ) = exp ( - \frac{{( x - {μ}_{x} )}^{2}}{2 {σ}_{x}^{2}} - \frac{{( y - {μ}_{y} )}^{2}}{2 {σ}_{y}^{2}} ) \qquad ( 1 )$$

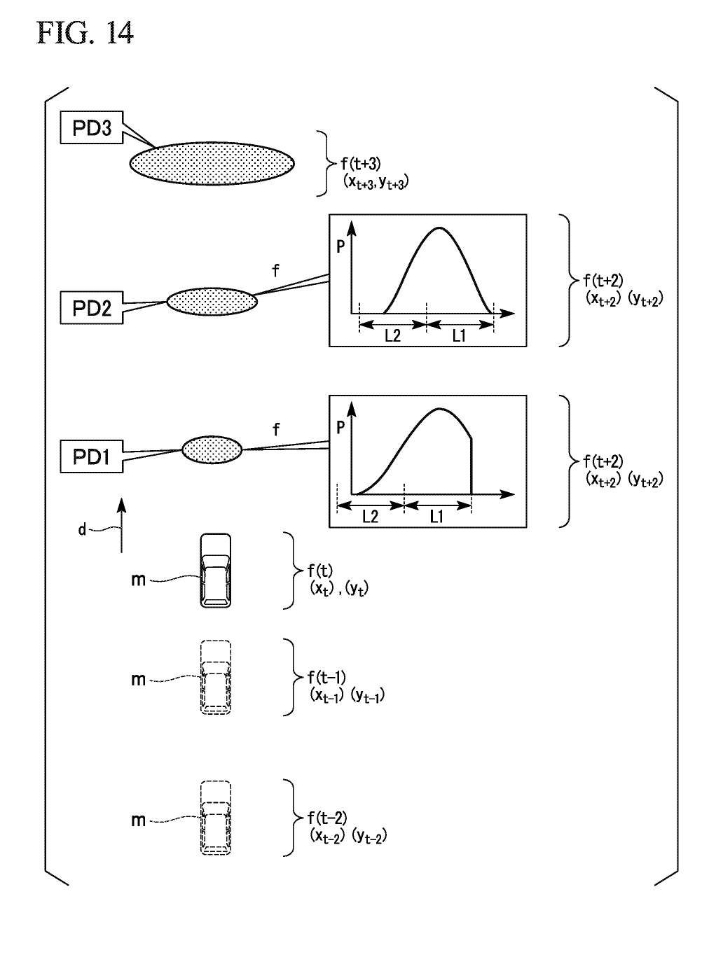

The second vehicle position prediction unit 113 derives the probability density distribution PD on the basis of the probability density function f, the lane information, and the transition of the current position, the previous position, or the future position of the second vehicle m. FIG. 14 is a view showing derivation of the probability density distribution PD of the future position of the second vehicle m. In FIG. 14, it is assumed that the second vehicle m is proceeding in a “d” direction.

When “t” represents the current position and when obtaining the probability density distribution PD1, the probability density function f is calculated using a current position (xₜ, yₜ) and previous positions (xₜ₋₁, yₜ₋₁) and (xₜ₋₂, yₜ₋₂) as parameters, and as a result, the probability density distribution PD is obtained. When obtaining the probability density distribution PD2, the probability density function f is calculated using a current position (xₜ, yₜ), previous positions (xₜ₋₁, yₜ₋₁) and (xₜ₋₂, yₜ₋₂), and a future position (xₜ₊₁, yₜ₊₁) as parameters, and as a result, the probability density distribution PD is obtained. When obtaining the probability density distribution PD3, the probability density function f is calculated using a current position (xₜ, yₜ), previous positions (xₜ₋₁, yₜ₋₁) and (xₜ₋₂, yₜ₋₂), and future positions (xₜ₊₁, yₜ₊₁) and (xₜ₊₂, yₜ₊₂) as parameters, and as a result, the probability density distribution PD is obtained.

In this way, the prediction is performed in a spreading manner reflecting the prediction result. As a result, when the second vehicle m is changing the path, for example, to the left direction, the average value μ_{y} follows up the tendency, and therefore, a tendency arises in which the probability density distribution PD is thickened on the left side. Therefore, when the second vehicle m is performing a lane change, it is possible to predict that the existence probability of the lane change destination is high.

The second vehicle position prediction unit 113 predicts the future position of the second vehicle m as the existence probability of each lane on the basis of the derived probability density distribution PD in f(t). For example, the second vehicle position prediction unit 113 integrates the probability density on a lane for each lane and thereby derives the existence probability of each lane.

Further, the second vehicle position prediction unit 113 may derive the probability density distribution PD by using the position history of the second vehicle m. For example, when the y direction displacement of the second vehicle m is continuously moving in one side, the probability distribution may be biased to a direction in which the y direction displacement is moved further than the range which the average value μ follows up. Specifically, the second vehicle position prediction unit 113 adjusts a skew (degree of skew: three-dimensional moment) in the normal distribution and can thereby bias the probability density regarding the y direction.

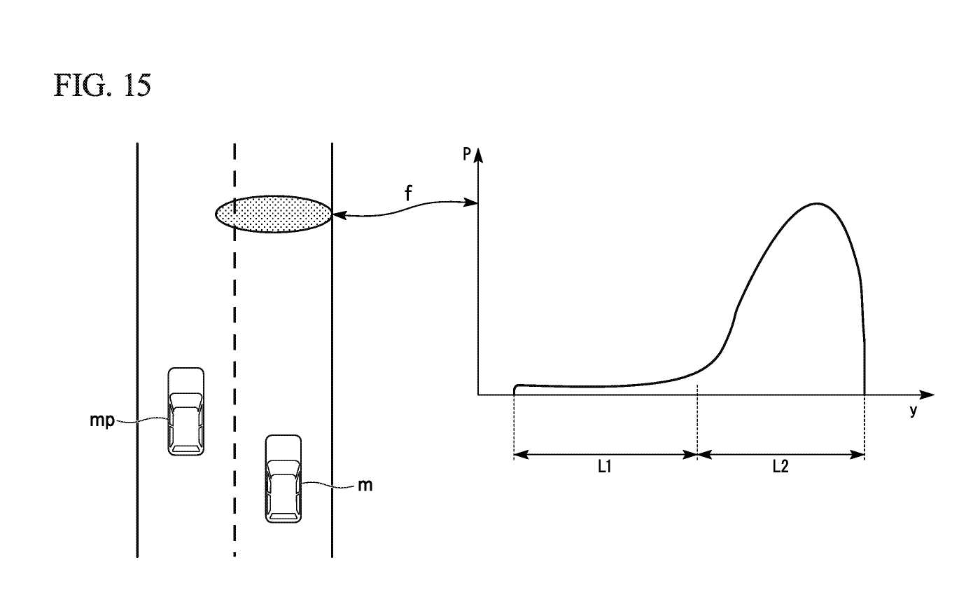

FIG. 15 is an example of a scene in which the probability density distribution PD is derived by using the position history of the second vehicle m. A peripheral second vehicle mp is a vehicle that is positioned around the second vehicle m. Hereinafter, the peripheral second vehicle mp is referred to as a third vehicle mp. In this scene, it is considered that the distance in the x direction between the second vehicle m and the third vehicle mp is small, and the possibility that the second vehicle m performs a lane change in the leftward direction is low. In this case, the second vehicle position prediction unit 113 causes the probability density distribution PD to be deviated in an opposite side of the third vehicle mp when seen from the second vehicle m. The second vehicle position prediction unit 113 causes the probability density to have a deviation, for example, that corresponds to the distance in the x direction between the second vehicle m and the third vehicle mp. In this case, the deviation may be increased as the distance in the x direction between the second vehicle m and the third vehicle becomes smaller in the future with reference to the relative speed between the second vehicle m and the third vehicle.

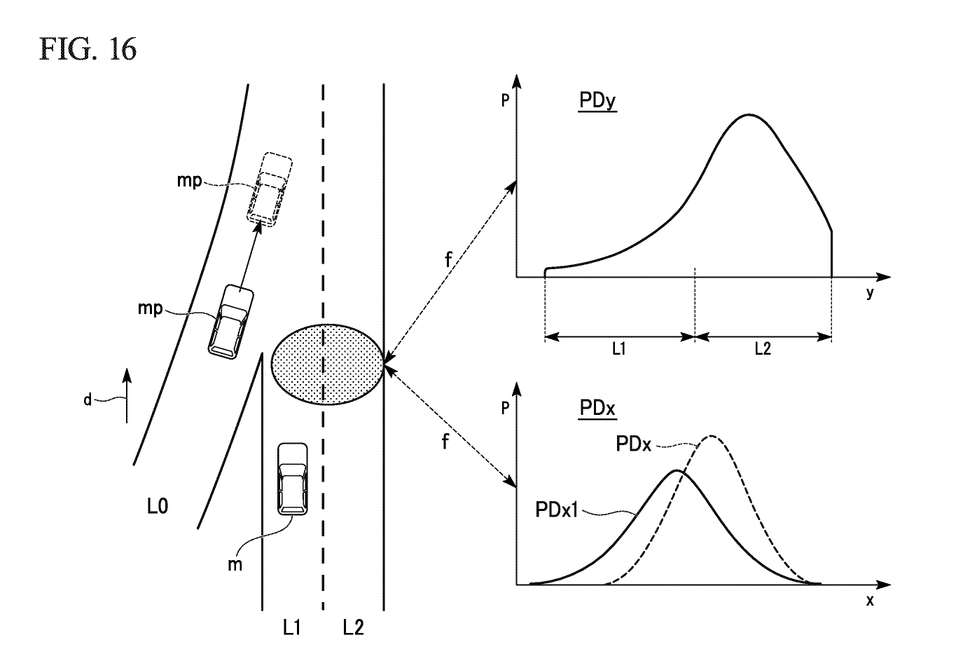

The second vehicle position prediction unit 113 may predict the future position of the third vehicle mp and may correct the probability density of the second vehicle m on the basis of the prediction result. FIG. 16 is a view showing an example of a scene in which a probability density distribution PDy of the second vehicle m is derived on the basis of the future prediction of the position of the third vehicle mp. The second vehicle position prediction unit 113 predicts a position at which the third vehicle mp will be present in the future when the third vehicle mp travels while keeping the same proceeding direction, and supposing that the second vehicle m avoids the position, the second vehicle position prediction unit 113 predicts the future position of the second vehicle m. In this scene, it is considered that the possibility that the second vehicle m performs a lane change in the rightward direction is high, and therefore, the second vehicle position prediction unit 113 causes the probability density to be deviated with respect to the y direction, and thereby, as shown in the probability density distribution PDy in FIG. 16, it is possible to set the probability density that the second vehicle m will be positioned in the future in the rightward direction to be high. The second vehicle position prediction unit 113 may not cause the probability density to be deviated and may lower the existence probability of a lane of a side at which the probability density is decreased by deviation to zero or a negligible value.

Similarly, with respect to the x direction, the second vehicle position prediction unit 113 derives a probability density distribution PDx1 of the second vehicle m on the basis of the future prediction of the position of the third vehicle mp. For example, in a case where the relative distance between the second vehicle m and the third vehicle mp is a threshold value or less, and the third vehicle mp travels while keeping the same proceeding direction, when the predicted position at which the third vehicle mp will be present in the future is positioned at a frontward position of the second vehicle m, if the second vehicle m does not perform (even when the second vehicle m performs) a lane change in the rightward direction, it is predicted that the second vehicle m decelerates. In this case, the second vehicle position prediction unit 113 may cause the probability density to be deviated to the rearward side with respect to the x direction, may increase dispersion, or may reduce kurtosis (fourth moment). In FIG. 16, the probability density distribution PDx is a probability density distribution when the future prediction of the position of the third vehicle mp is not considered.

### Travel Control

The travel control unit 120 sets a control mode to an automated driving mode or a manual driving mode according to a control by the control switch unit 122 and controls a control target in accordance with the set control mode. The travel control unit 120 reads the action plan information 136 that is generated by the action plan generation unit 106 at the automated driving mode and controls the control target on the basis of the event that is included in the read action plan information 136. When the event is a lane change event, the travel control unit 120 determines the control amount (for example, a rotation number) of the electric motor in the steering device 92 and the control amount (for example, a throttle-opening degree of an engine, a shift step, and the like) of the ECU in the travel drive force output device 90 in accordance with the control plan that is generated by the control plan generation unit 114. The travel control unit 120 outputs information indicating the control amount that is determined for each event to the corresponding control target. Thereby, each device (the travel drive force output device 90, the steering device 92, and the brake device 94) as a control target can control the device as the control target in accordance with the information indicating the control amount that is input from the travel control unit 120. Further, the travel control unit 120 appropriately adjusts the determined control amount on the basis of a detection result of the vehicle sensor 60.

The travel control unit 120 controls the control target on the basis of an operation detection signal that is output by the operation detection sensor 72 at the manual driving mode. For example, the travel control unit 120 outputs the operation detection signal that is output by the operation detection sensor 72 as is to each device as the control target.

The control switch unit 122 switches the control mode of the vehicle M by the travel control unit 120 from the automated driving mode to the manual driving mode or from the manual driving mode to the automated driving mode on the basis of the action plan information 136 that is generated by the action plan generation unit 106. The control switch unit 122 switches the control mode of the vehicle M by the travel control unit 120 from the automated driving mode to the manual driving mode or from the manual driving mode to the automated driving mode on the basis of the control mode designation signal that is input from the switch 80. That is, the control mode of the travel control unit 120 can be arbitrarily changed while traveling or while stopping by the operation of the driver or the like.

The control switch unit 122 switches the control mode of the vehicle M by the travel control unit 120 from the automated driving mode to the manual driving mode on the basis of the operation detection signal that is input from the operation detection sensor 72. For example, the control switch unit 122 switches the control mode of the travel control unit 120 from the automated driving mode to the manual driving mode when the operation amount that is included in the operation detection signal exceeds a threshold value, that is, when an operation device 70 accepts an operation at the operation amount that exceeds the threshold value. For example, the control switch unit 122 switches the control mode of the travel control unit 120 from the automated driving mode to the manual driving mode when the steering wheel, the accelerator pedal, or the brake pedal is operated at the operation amount that exceeds the threshold value by the driver in a case where the vehicle M is automatically traveling by the travel control unit 120 that is set in the automated driving mode. Thereby, the vehicle control apparatus 100 can switch the driving mode to the manual driving mode immediately, without an operation of the switch 80, by an operation that is abruptly performed by the driver when an object such as a person dashes into the road or when a frontward traveling vehicle suddenly stops. As a result, the vehicle control apparatus 100 can respond to an operation in an emergency by the driver, and it is possible to enhance safety when traveling.

According to the vehicle control apparatus 100 of the first embodiment described above, the second vehicle position prediction unit 113 derives a probability density distribution PD on the basis of the detection result of a second vehicle m that is detected by the detection unit DT and lane information of the map information 132 and predicts a future position of the second vehicle m on the basis of the derived probability density distribution PD, and thereby, it is possible to predict the position of the second vehicle with good accuracy.

### Second Embodiment

A second embodiment is described below. A vehicle control apparatus 100 in the second embodiment is different from the first embodiment in that the probability density of the probability density distribution PD is deviated on the basis of information that affects the behavior of the second vehicle m which is included in the map information 132. Hereinafter, such a difference is mainly described.

The second vehicle position prediction unit 113 derives the probability density distribution PD on the basis of the probability density function and the current position, the previous position, and the predicted future position of the second vehicle m. Further, the second vehicle position prediction unit 113 causes the probability density of the probability density distribution PD to be deviated on the basis of information that affects the behavior of the second vehicle m which is included in the map information 132 such as, for example, the type of a lane on which the vehicle M is traveling.

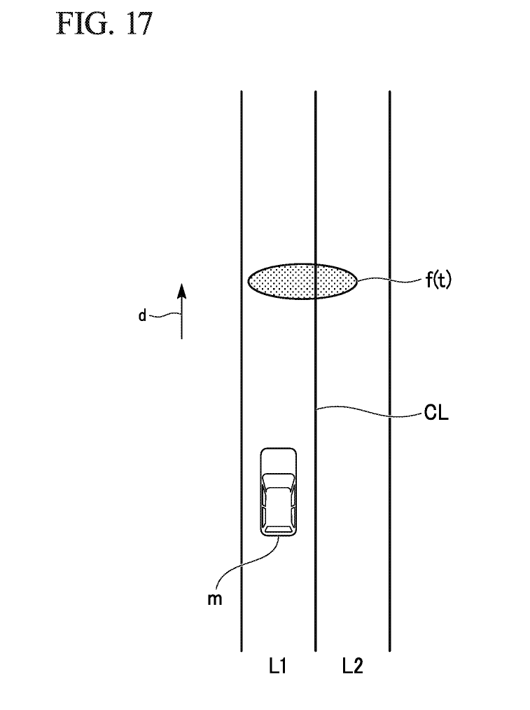

FIG. 17 is a view showing a scene in which the probability density distribution PD is corrected. A lane on which the second vehicle m is traveling is, for example, a road having two lanes (L1 and L2) of which the proceeding direction is the “d” direction, and it is assumed that the center line CL indicates lane change prohibition. Further, it is assumed that the second vehicle position prediction unit 113 derives the probability density distribution PD at a time (t).

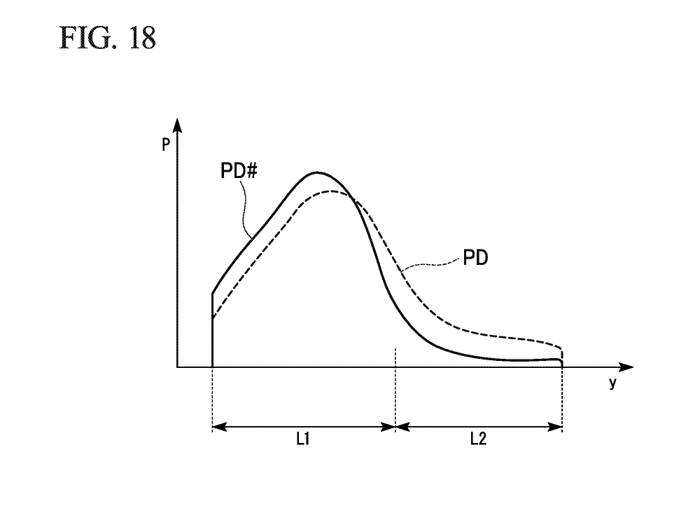

FIG. 18 is an example of a probability density distribution PD# when derived in consideration of the type of a lane.

The second vehicle position prediction unit 113 causes the probability density of the probability density distribution PD to be deviated on the basis of information indicating that the center line CL indicates lane change prohibition which is included in the map information 132. In this case, for example, the second vehicle position prediction unit 113 causes the probability density of the probability density distribution PD to be deviated such that a probability of existence in the future on the lane L1 on which the second vehicle m is traveling is enhanced.

The second vehicle position prediction unit 113 may cause the probability density of the probability density distribution PD to be deviated by using information that affects the behavior of the second vehicle m which is included in the map information 132 such as traffic regulation information and information that indicates overtaking prohibited. For example, when there is a traffic regulation with respect to the lane L1 in the proceeding direction of the second vehicle m, the second vehicle position prediction unit 113 causes the probability density to be deviated such that a probability in which the second vehicle m is present on the adjacent lane L2 in the future is enhanced on the basis of the information that indicates the traffic regulation.

The second vehicle position prediction unit 113 may derive the probability density with respect to the proceeding direction of the second vehicle m by using information which is included in the map information 132. For example, when the number of lanes decreases or the number of lanes increases in the proceeding direction of the second vehicle m, the second vehicle position prediction unit 113 causes the probability density to be deviated in the proceeding direction of the vehicle m or in an opposite direction of the proceeding direction or increases the dispersion with respect to the proceeding direction of the second vehicle m or an opposite direction of the proceeding direction compared to a case in which the number of lanes is neither decreased nor increased on the basis of the information that indicates the decrease of the number of lanes or the increase of the number of lanes which is included in the map information 132.

For example, when the number of lanes decreases in the proceeding direction of the second vehicle m, the second vehicle position prediction unit 113 may cause the probability density with respect to the proceeding direction of the second vehicle m to be deviated in the opposite direction of the proceeding direction of the second vehicle m or may increase the dispersion compared to a case in which the number of lanes is not decreased. In this case, this is because the probability in which the second vehicle m decelerates is high. For example, when the number of lanes increases in the proceeding direction of the second vehicle m, the second vehicle position prediction unit 113 may cause the probability density with respect to the proceeding direction of the second vehicle m to be deviated in the proceeding direction of the second vehicle m or may increase the dispersion compared to a case in which the number of lanes is not increased. In this case, this is because the probability in which the second vehicle m accelerates is high.

The present embodiment is described using an example in which the second vehicle position prediction unit 113 corrects the probability density distribution PD by using information that affects the behavior of the second vehicle m; however, the second vehicle position prediction unit 113 may derive the probability density distribution PD on the basis of information that affects the behavior of the second vehicle m, the position of the second vehicle m, the third vehicle mp, and the probability density function.

According to the vehicle control apparatus 100 in the second embodiment described above, the second vehicle position prediction unit 113 corrects the probability density distribution PD on the basis of information that affects the behavior of the second vehicle m which is included in the map information 132, and thereby, it is possible to predict the future position of the second vehicle m with further good accuracy.

The second vehicle position prediction unit 113 may derive the probability density distribution PD by combining the methods described in the above first and second embodiments.

Although embodiments of the invention have been described with reference to the drawings, the present invention is not limited to the embodiments, and a variety of changes and substitutions can be added without departing from the scope of the invention.

### DESCRIPTION OF THE REFERENCE SYMBOLS

20: FINDER

30: RADAR

40: CAMERA

50: NAVIGATION DEVICE

60: VEHICLE SENSOR

70: OPERATION DEVICE

72: OPERATION DETECTION SENSOR

80: SWITCH

90: TRAVEL DRIVE FORCE OUTPUT DEVICE

92: STEERING DEVICE

94: BRAKE DEVICE

100: VEHICLE CONTROL APPARATUS

102: OUTSIDE RECOGNITION UNIT

104: VEHICLE POSITION RECOGNITION UNIT

106: ACTION PLAN GENERATION UNIT

108: SECOND VEHICLE-TRACKING UNIT

113: SECOND VEHICLE POSITION PREDICTION UNIT

114: CONTROL PLAN GENERATION UNIT

120: TRAVEL CONTROL UNIT

122: CONTROL SWITCH UNIT

130: STORAGE UNIT

M: VEHICLE (FIRST VEHICLE)

m: SECOND VEHICLE

What is claim is:

1.-13. (canceled)

14. A vehicle control apparatus that is provided at least on a first vehicle, the apparatus comprising:
a detection unit that detects a second vehicle which is traveling around the first vehicle; and
a prediction unit that predicts a future position of the second vehicle, based on a detection result of the detection unit and lane information of a road around the second vehicle,
wherein the prediction unit predicts a future position of the second vehicle as an existence probability of each lane.

15. The vehicle control apparatus according claim 14,
wherein the prediction unit derives a probability density distribution of an existence of the second vehicle with respect to the lane information of the road and predicts a future position of the second vehicle as an existence probability of each lane, based on the derived probability density distribution.

16. The vehicle control apparatus according to claim 15,
wherein the prediction unit derives the probability density distribution, based on a position history of the second vehicle.

17. The vehicle control apparatus according to claim 15,
wherein the prediction unit derives the probability density distribution, based on information of an increase or decrease of a lane.

18. The vehicle control apparatus according to claim 15,
wherein the detection unit further detects a third vehicle which is traveling around the second vehicle, and
the prediction unit derives a probability density distribution of an existence of the second vehicle with respect to the lane information of the road, reflecting a position of the third vehicle that is detected by the detection unit.

19. The vehicle control apparatus according to claim 15,
wherein the prediction unit derives the probability density distribution, based on information that affects a behavior of the second vehicle.

20. A vehicle control apparatus that is provided at least on a first vehicle, the apparatus comprising:
a detection unit that detects a second vehicle which is traveling around the first vehicle; and
a prediction unit that predicts a future position of the second vehicle, based on a detection result of the detection unit and lane information of a road around the second vehicle,
wherein the prediction unit predicts, based on the future position of the second vehicle that is predicted by the prediction unit, a future position of the second vehicle that is a more future position than the predicted future position of the second vehicle.

21. A vehicle control apparatus that is provided at least on a first vehicle, the apparatus comprising:
a detection unit that detects a second vehicle which is traveling around the first vehicle;
a prediction unit that predicts a future position of the second vehicle, based on a detection result of the detection unit and lane information of a road around the second vehicle; and
a second vehicle-tracking unit that estimates, when the second vehicle becomes undetected by the detection unit, based on the future position of the second vehicle that is predicted by the prediction unit, a position of the second vehicle that becomes undetected by the detection unit.

22. A vehicle control apparatus that is provided at least on a first vehicle, the apparatus comprising:
a detection unit that detects a second vehicle which is traveling around the first vehicle;
a prediction unit that predicts a future position of the second vehicle, based on a detection result of the detection unit and lane information of a road around the second vehicle; and
a second vehicle-tracking unit that determines, based on a comparison of a future position that is predicted by the prediction unit of the second vehicle which is previously detected by the detection unit with a position of a second vehicle which is detected by the detection unit, whether or not the second vehicle which is previously detected by the detection unit is identical to the second vehicle which is detected by the detection unit.

23. A vehicle control method, comprising:
detecting a second vehicle which is traveling around a first vehicle; and
predicting a future position of the second vehicle as an existence probability of each lane, based on a detection result of the detected second vehicle and lane information of a road.

24. A vehicle control program that causes a computer of a vehicle control apparatus which is provided at least on a first vehicle to:
detect a second vehicle which is traveling around the first vehicle; and
predict a future position of the second vehicle as an existence probability of each lane, based on a detection result of the detected second vehicle and lane information of a road.
